(19) United States
(12) Patent Application Publication
(10) Pub. No.: US 2010/0329684 A1
(43) Pub. Date: Dec. 30, 2010

(54) CHANNEL EXPRESS/ADD OPTICAL MODULE AND CHANNEL EXPRESS/ADD METHOD IN OPTICAL ADD/DROP MULTIPLEXER NODE USING THE SAME

(75) Inventors: Sang Soo LEE, Daejeon-city (KR); Hwan Seok Chung, Daejeon-city (KR); Sun Hyok Chang, Daejeon-city (KR); Kwangjoon Kim, Daejeon-city (KR)

Correspondence Address: AMPACC Law Group, PLLC;LOADING..., 6100 219th Street SW, Suite 580, Mountlake Terrace, WA, 98043, US

(73) Assignee: Electronics and Telecommunications Research Institute, Daejeon-city (KR)

(21) Appl. No.: 11/933,100

(22) Filed: Oct. 31, 2007

(30) Foreign Application Priority Data
Dec. 6, 2006 (KR) 10-2006-0123398

(51) Int. Cl. H04J 14/02

(52) U.S. Cl. 398/83

(57) ABSTRACT

Provided are a channel express/add optical module and a method of channel express/add in an optical add/drop multiplexer node using the channel express/add optical module. The channel express/add optical module comprises: a multiplexer/demultiplexer which demultiplexes a multiplexed optical signal having a plurality of wavelengths into individual wavelength optical signals or multiplexes a plurality of different wavelength optical signals; a plurality of 1×2 switches each of which includes a first output end that guides the demultiplexed different wavelength optical signals to output them thereto and a second output end through which new wavelength optical signals; and a plurality of reflectors each of which reflects the optical signal output to the first output end so that the optical signal is feedback to the multiplexer/demultiplexer via the 1×2 switches.

The channel express/add optical module and the method of channel express/add in an OADM using this optical module are applied to a reconfigurable optical add/drop multiplexer system, and can express/add multiplexed channels in a node using a simple structure.

### CROSS-REFERENCE TO RELATED PATENT APPLICATIONS

This application claims the priority of Korean Patent Application No. 10-2006-0123398, filed on Dec. 6, 2006, in the Korean Intellectual Property Office, the disclosure of which is incorporated herein in its entirety by reference.

### BACKGROUND OF THE INVENTION

1. Field of the Invention

The present invention relates to a channel express/add optical module and a channel express/add method at an optical add/drop multiplexer (OADM) node using the same, and more particularly, to an optical channel express/add module and a method thereof which express and add some signals of optical signals optically multiplexed by an OADM node. The present invention was supported by the IT R&D program of Ministry of Information and Communication Republic of Korea (MIC). [2006-S-059-01, ASON based Metro Photonic Cross-Connect Technology]

2. Description of the Related Art

Since the advent of wired communication, electric signal transmission over wires was a mainstream technology, but a technology that converts electric signals into optical signals to transmit them through optical fiber has been generally used since 1980's.

Devices employing various technologies have been continuously developed, ranging from plesiochronous digital hierarchy (PDH) which is an asynchronous optical transmission device based on transmission of a DS-n unit layer in an optical transmission network to a synchronous optical network (SONET)/synchronous digital hierarchy (SDH) group, which is the most of the current optical transmission devices, and a wavelength division multiplexing device which is used in the recent core and metro backbone.

Moreover, different forms of optical transmission devices are used depending on where service providers are placed in a network. In an access and a metro network areas, SONET/SDH, multi-service provisioning platform (MSPP), or optical Ethernet devices are used in order to multiplex traffic of users. WDM devices have been gradually introduced to a metro backbone and an interregional transmission networks.

In a core backbone network, it is general to use a long-distance high capacity wavelength division multiplexing (WDM) system of several hundreds Gb/sec or above, and high capacity WDM device for ultra-long distance of 2,000 km or above has been introduced.

A WDM device which wavelength-division-multiplexes a plurality of high-speed signals and transmits them to an optical path comprising of one optical fiber is now employed in most backbone and metro networks. Such devices using a WDM system are classified into a linear system type and an add/drop multiplexer (ADM) or optical add/drop multiplexer (OADM) system type according to network configuration types. The linear system type provides a point-to-point connection between two points, and the ADM or OADM system type configures an optical transmission network as a ring so that some traffic or channels can be inserted into or extracted from individual nodes.

It is essential for the WDM devices to have an OADM function which can selectively add/drop optical wavelengths and pass some of them.

The OADM system includes a fixed OADM system which can add/drop optical signals of a fixed wavelength, and a reconfigurable optical add-drop multiplexer (ROADM) which can add/drop wavelengths of an optical signal dynamically according to changes in circumstances.

The ROADM can remotely reconfigure a network, and thus can satisfy significant needs of efficiency of network and cost reduction.

Generally, the ROADM system uses optical modules for a channel add/drop function.

FIG. 1 is a diagram of the conventional channel express/add module.

FIG. 1 is originally shown in a paper entitled “Advanced in Planar Lightwave Circuits” which was reported by David J. Dougherty from JDS Uniphase Corporation, USA at the Optical Fiber Communication Conference & Exposition and the National Fiber Optic Engineers Conference (OFC/NFOEC) 2005.

In the ROADM node, a ROAM module functions for channel express and add, and a DEMUX-T module functions for channel drop.

FIG. 1 illustrates only the ROAM module. To perform the channel express and add function, the ROAM module includes a multiplexer 140, a demultiplexer 110, an optical switch 120, and an optical attenuator array 130, so that the structure of the ROAM module is very complicated.

Also, since plenty of active components are used in the ROAM module, more amount of electricity is consumed. Moreover, because of a plurality of optical components, there is a disadvantage that the optical module has rather large polarization mode dispersion of 1.0 ps and polarization dependence loss of approximately 1.0 dB.

In addition, since the multiplexer 140 and the demultiplexer 110 are used together, their channel wavelength bandwidth characteristics should be exactly the same.

The U.S. Pat. No. 7,106,930 filed by JDS Uniphase Corporation USA is for improving these disadvantages.

This patent relates to a wavelength blocker, which demultiplexes wavelength multiplexed signals according to wavelength channels and interrupts or allows light to pass along each channel using shutters.

To this end, according to this patent, an optical device comprises a directional coupler, an arrayed waveguide grating filter, shutters, and a reflector.

Since proceeding of an optical signal from each channel is selectively interrupted using the shutter allocated in each channel, the optical device can be used as a wavelength blocker for channel add/drop in an OADM node.

However, the optical device according to this invention can perform channel expressing but cannot perform channel adding.

There is U.S. Pat. No. 6,487,336 relating to optical fiber communication devices, which was filed by General Photonics Corporation, but the devices in this invention cannot perform a channel expressing and adding function.

### SUMMARY OF THE INVENTION

The present invention provides a channel express/add optical module which simplifies the structure of a channel express/add module and thus can minimize polarization mode dispersion and polarization dependence loss, and a channel express/add method in an optical add/drop multiplexer node using the channel express/add optical module.

According to an aspect of the present invention, there is provided a channel express/add optical module comprising a multiplexer/demultiplexer which demultiplexes a multiplexed optical signal having a plurality of wavelengths into individual wavelength optical signals or multiplexes a plurality of different wavelength optical signals; a plurality of 1×2 switches each of which includes a first output end that guides the demultiplexed different wavelength optical signals to output them thereto and a second output end through which receive new wavelength optical signals; and a plurality of reflectors each of which reflects the optical signal output to the first output end so that the optical signal is feedback to the multiplexer/demultiplexer via the 1×2 switches.

According to another aspect of the present invention, there is provided a method of channel express/add in an OADM node using a channel express/add module, the method comprising: demultiplexing a multiplexed optical signal having a plurality of wavelengths into individual wavelength optical signals having different wavelengths; outputting the demultiplexed wavelength optical signals to a first output end of a 1×2 switch and receiving new wavelength optical signals through a second output end of the 1×2 switch; reflecting the optical signals output to the first output end; and multiplexing the reflected optical signals having different wavelengths or the new wavelength optical signals input through the second output end.

According to the present invention, an channel express/add optical module uses only a multiplexer to perform a channel add/drop function in an OADM node while the conventional optical module consists of an optical divider, a multiplexer, a demultiplexer in order to perform the same function.

The present invention does not use a demultiplexer which is economically advantageous, and consequently a temperature control circuit required in the demultiplexer is not needed and also power consumption is minimized since there is no need to control the temperature. Moreover, without the demultiplexer, the overall size of the optical module can be smaller.

In the view of performance, since the single multiplexer multiplexes and demultiplexes a signal according to the present invention, it is not necessary to adjust the transmission bandwidths of a multiplexer and a demultiplexer to be the same, which was required in the conventional technology. Moreover, if a Faraday rotator is used as a reflector, it can be possible to compensate for polarization mode dispersion or polarization dependence loss of the optical module.

### BRIEF DESCRIPTION OF THE DRAWINGS

The above and other features and advantages of the present invention will become more apparent by describing in detail exemplary embodiments thereof with reference to the attached drawings in which:

FIG. 1 is a diagram of the conventional channel express/add module;

FIG. 2 is a diagram of an array of a channel express/add module according to an embodiment of the present invention;

FIG. 3 is a diagram showing the input/output structure of each of the optical switches in the channel express/add module in FIG. 2; and

FIG. 4 is a flowchart illustrating a method of channel express/add in an optical add/drop multiplexer node using a channel express/add module, according to an embodiment of the present invention.

### DETAILED DESCRIPTION OF THE INVENTION

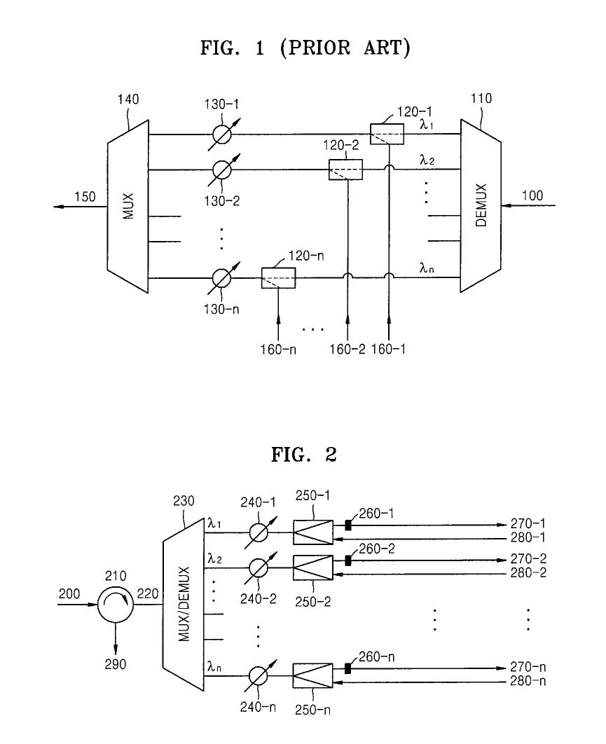

FIG. 2 is a diagram of an array of a channel express/add module according to an embodiment of the present invention. Referring to FIG. 2, the channel express/add module includes an optical circulator 210, an arrayed waveguide grating (AWG) filter 230, a plurality of optical attenuator 240-1, . . . , n, a plurality of 1×2 optical switches 250-1, . . . , n, and a plurality of reflectors 260-1, . . . , n.

The procedures of optical channel expressing and adding by the channel express/add module according to the present invention will now be described below.

The optical circulator 210 includes a first port 200 from which wavelength multiplexed signals λ1, λ2, . . . , λn are input, and a second port 220 to which the signals λ1, λ2, . . . , λn are output, and a third port 290.

The wavelength multiplexed signals λ1, λ2, . . . , λn are input to the arrayed waveguide grating filter 230.

The wavelength multiplexed signals λ1, λ2, . . . , λn are wavelength-separated by the arrayed waveguide grating filter 230 and are output to separate output ports of the arrayed waveguide grating filter 230.

The wavelength optical signals which are output to individual output ports are input to the plurality of optical attenuators 240-1, . . . , n, and to the plurality of 1×2 optical switches 250-1, . . . , n.

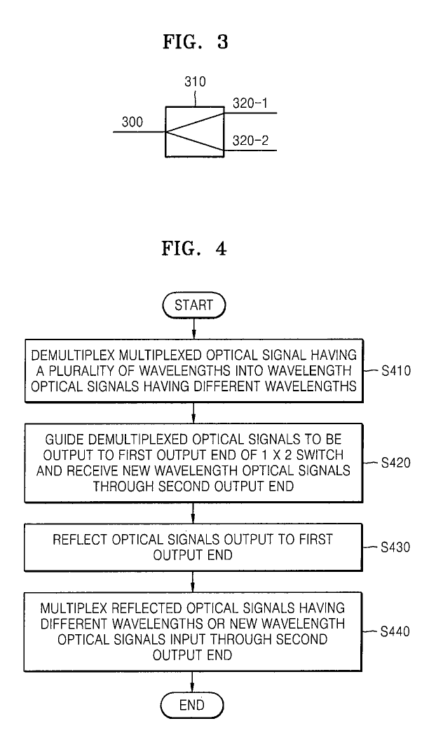

FIG. 3 is a diagram showing the input/output structure of each of the optical switches in the channel express/add module in FIG. 2. In FIG. 3, the optical switch is represented by a reference numeral 310. The optical switch 310 has a first port 300, a second port 320-1, and a third port 320-2, and the second port 320-1 includes a reflector 260 at its output end.

A transmission path of an optical signal in the optical switch 310 can be either a first path where the signal is input from the first port 300 and output to the second port 320-1 or a second path where the signal is input from the first port 300 and output to the third port 320-2, in response to an external control signal.

In the case of the first path, the individual wavelength optical signals are reflected by the each of the reflectors 260-1, . . . , n, and are input to the second port 220 of the optical circulator 210 via the optical attenuators 240-1, . . . , n and the arrayed waveguide grating filter 230.

Finally, the optical signals are output to the third port 290 of the optical circulator 210.

In this case, since the optical signals which are input through the optical attenuators 240-1, . . . , n can be retransmitted after individual channel powers are adjusted, a channel express function can be performed in an optical add/drop multiplexer (OADM) node.

The procedures of channel adding according to the present invention will now be described below with reference to FIGS. 2 and 3.

New channels to be added are routed through the second path of the optical path, but the new channel is input from the third port 320-1 and output to the first port 300.

The new channel signals 280-1, . . . , n are output passing through the optical attenuators 240-1, . . . , n, the arrayed waveguide grating (AWG) filter 230, and the optical circulator 210.

The reflectivity of each of the reflectors 260-1, . . . , n is appropriately adjusted so that some channels are reflected to express and can be continued and some channels pass through the reflectors to be dropped.

When a Faraday rotator is used as a reflector, the polarization dependent loss and the polarization mode dispersion which occur in the optical circulator, a multiplexer, optical attenuators, and optical switches can be compensated for.

The channel express/add module according to the present invention may use appropriate taps and photo detectors for detecting optical power.

Referring to FIG. 3, when a channel express/continue function is performed, an input port is the first port 300 and an output port is the second port 320-1, and when a channel add function is performed, the third port 320-2 acts as an input port and the first port 300 acts as the output port.

FIG. 4 is a flowchart illustrating a method of channel express/add in an OADM node using a channel express/add module, according to an embodiment of the present invention.

Multiplexed optical signal which has a plurality of wavelengths input from an optical circulator is demultiplexed into individual wavelength optical signals (S410).

The demultiplexed individual wavelength optical signals are guided to a first output end of one of 1×2 switches and new wavelength optical signals are received through a second output end (S420).

The optical signals output to the first output end are reflected to be feedback to a multiplexer/demultiplexer via the 1×2 switches (S430).

The reflected different wavelength optical signals or new wavelength optical signals input through the second output end are multiplexed and transmitted to the next optical add/drop multiplexer (OADM) node (S440).

According to the current embodiment of the present invention, channel express is performed on the individual wavelength optical signals reflected in operation S430 and channel add is performed on the new wavelength optical signals in operation S420.

While the present invention has been particularly shown and described with reference to exemplary embodiments thereof, it will be understood by those of ordinary skill in the art that various changes in form and details may be made therein without departing from the spirit and scope of the present invention as defined by the following claims.

1. A channel express/add optical module comprising:
an integrated multiplexer/demultiplexer configured to demultiplex a multiplexed optical signal having a plurality of wavelengths into individual wavelength optical signals or multiplexes a plurality of different wavelength optical signals;
a plurality of 1×2 switches, each switch including a first output end and a second output end, the first output end being configured to guide a demultiplexed optical signal to output the demultiplexed optical signal therefrom, the second output end being configured to receive a new wavelength optical signal; and
a plurality of reflectors configured to reflect the optical signals output from the first output ends so that the optical signals are reflected to the multiplexer/demultiplexer via the 1×2 switches.

2. The channel express/add optical module of claim 1, further comprising:
a plurality of optical attenuators configured to reduce the intensity of at least one of the demultiplexed individual wavelength optical signals, the optical signals which are reflected by the reflectors, and the new wavelength optical signals input through the second output end.

3. The channel express/add optical module of claim 1, wherein the reflectors are Faraday rotators.

4. The channel express/add optical module of claim 1, wherein the multiplexer/demultiplexer is an arrayed waveguide grating filter.

5. The channel express/add optical module of claim 1, further comprising:
a plurality of tap couplers configured to extract a part of the demultiplexed individual wavelength optical signals or a part of the optical signals reflected by the reflectors; and
a plurality of photo detectors configured to measure the intensity of the extracted optical signal.

6. The channel express/add optical module of claim 1, further comprising:
an optical circulator configured to guide the multiplexed optical signal to the multiplexer/demultiplexer and to output the optical signals reflected by the reflectors and the multiplexed optical signal obtained by multiplexing the new wavelength optical signals input through the second output end to a predetermined optical add/drop multiplexer (OADM) node.

7. A method of channel express/add in an OADM node using a channel express/add module, the method comprising:
demultiplexing a multiplexed optical signal having a plurality of wavelengths into individual wavelength optical signals having different wavelengths;
outputting the demultiplexed wavelength optical signals to a first output end of a 1×2 switch;
receiving new wavelength optical signals through a second output end of the 1×2 switch;
reflecting the optical signals output to the first output end; and
multiplexing the reflected optical signals having different wavelengths or the new wavelength optical signals input through the second output end.

8. The method of claim 7, further comprising:
reducing the intensity of at least one of the demultiplexed wavelength optical signals having a plurality of wavelengths, the reflected optical signals having a plurality of wavelengths and the new wavelength optical signals input through the second output end.

9. The method of claim 7, further comprising:
extracting a part of the demultiplexed wavelength optical signals or a part of the reflected optical signals having different wavelengths; and
measuring the intensity of the extracted signal.

10. The method of claim 7, further comprising:
controlling the reflectivity of each of the reflectors to reflect a portion of power of the optical signals output to the first output end and allow a remainder of power of the optical signals to pass.

11. The channel express/add optical module of claim 1, wherein the reflectors are configured to partially reflect an input optical signal.

12. The method of claim 7, wherein the reflecting the optical signals comprises selectively reflecting a portion of the optical signals.
